(19) United States
(12) Patent Application Publication
(10) Pub. No.: US 2025/0044075 A1
(43) Pub. Date: Feb. 6, 2025

(54) METHODS AND SYSTEMS FOR THREE-DIMENSIONAL IMAGING OF A TRANSPARENT BIOLOGICAL OBJECT IN A BIOLOGICAL SAMPLE BY FULL-FIELD OPTICAL TOMOGRAPHY

(71) Applicants: CENTRE NATIONAL DE LA RECHERCHE SCIENTIFIQUE, PARIS (FR); ECOLE SUPERIEURE DE PHYSIQUE ET DE CHIMIE INDUSTRIELLES DE LA VILLE DE PARIS, PARIS (FR)

(72) Inventors: Albert Claude BOCCARA, PARIS (FR); Martine BOCCARA, PARIS (FR); Olivier THOUVENIN, Chatillon (FR)

(73) Assignees: CENTRE NATIONAL DE LA RECHERCHE SCIENTIFIQUE, PARIS (FR); ECOLE SUPERIEURE DE PHYSIQUE ET DE CHIMIE INDUSTRIELLES DE LA VILLE DE PARIS, PARIS (FR)

(21) Appl. No.: 18/564,270

(22) PCT Filed: May 23, 2022
(86) PCT No.: PCT/EP2022/063907

§ 371 Date: Nov. 27, 2023

(30) Foreign Application Priority Data
May 28, 2021 (FR) FR2105600

(51) Int. Cl. G01B 9/02091; G01B 9/02015; G01B 9/02055

(52) U.S. Cl. CPC G01B 9/02091; G01B 9/02024; G01B 9/02079

(57) ABSTRACT

A three-dimensional imaging system including a light source configured to emit a beam of spatially incoherent light, having a given central length, configured to illuminate a biological sample being transmitted; an optical imaging system including a microscope lens with a given object focal plane near which the sample is positioned; mechanisms for axially moving the microscope lens relative to the sample; a two-dimensional acquisition device including a plurality of elementary detectors arranged in a detection plane optically conjugate with the object focal plane and a processing unit. For each section of a biological object of the sample, a plurality of two-dimensional interferometric signals resulting from optical interference between the illumination beam and a beam scattered by an object field of the section are acquired and at least a first image is calculated from the plurality of two-dimensional interferometric signals.

### FIELD

The present description relates to methods and systems for three-dimensional imaging of a transparent biological object in a biological sample by full-field optical tomography. It is applicable especially to cellular and intracellular imaging.

### BACKGROUND

Biological objects, such as especially cells or clusters of cells, can be studied at the submicron scale using optical microscopy, but most biological studies use fluorescence microscopy, which requires the sample to be genetically or chemically modified.

In cases where sample preservation is essential, a few alternatives based on the intrinsic optical properties of biological objects have been developed. Among them, phase contrast microscopy (see for example Lacey, A [Ref 1]), differential interference contrast microscopy (see for example Pluta, M [Ref 2]) or digital holography (see for example Amos, W. B. et al. [Ref 3]) make it possible to visualise cells in 2D and 3D environments.

Optical tomography imaging techniques make it possible to generate deep cross-sectional images of biological objects. Among these techniques, optical coherence tomography (OCT), which is based on spectral broadband light interference microscopy, and confocal microscopy, which uses geometric filtering, are especially known. Both techniques require a two-dimensional scan of the sample to generate an image in front of the sample.

More recently, a technique for acquiring images by incoherent light full-field interference microscopy, known as full-field OCT (or FF-OCT), has been developed. The full-field OCT imaging technique is described for example in the chapter “Time Domain Full Field Optical Coherence Tomography Microscopy Time Domain” by Harms, F. et al [Ref. 4] in the Wolfgang Drexler book “Optical Coherence Tomography”, as well as in the French patent FR2817030 [Ref. 5].

The full-field OCT imaging technique is based on the use of the light backscattered by a sample when it is lit by a light source with a low temporal coherence length, and in particular the use of the light backscattered by microscopic cellular and tissue structures in the case of a biological sample. This technique utilises the low temporal and spatial coherence of a light source to isolate the light backscattered by a virtual deep slice in the sample. The use of an interferometer makes it possible to generate, by an interference phenomenon, an interference signal representative of the light selectively coming from a given slice of the sample, and to remove the light coming from the rest of the sample.

The full-field OCT imaging technique allows three-dimensional images to be obtained with a typical resolution in the order of 1 μm, which is higher than the resolutions in the order of 10 μm likely to be obtained with other conventional OCT techniques such as spectral domain OCT (known by the acronym “Fourier-Domain OCT”). With such a high resolution, it is especially possible to visualise most of the tissue structures of blood vessels, their walls, collagen, adipocytes, etc. In addition, this technique is particularly fast: using a full-field OCT microscope, it is thus possible to generate an image representative of a deep slice with a surface area of several cm² in just a few minutes.

In addition to obtaining a structural map of a biological sample, another challenge for endogenous optical imaging is to extract specific information to deduce biochemical properties at the cellular level.

French patent FR 3034858 [Ref. 6] describes an imaging method by full-field interference microscopy called DC-FFOCT (for “Dynamic Contrast FFOCT”) that allows access to information that is not perceptible by means of images obtained according to conventional full-field OCT techniques, for example the internal structures of cells (membrane, nucleus, cytoplasm, especially). This imaging method is based on the analysis of temporal variations in intensity of interferometric signals induced by variations in the path difference associated with motions of vesicles, mitochondria and cell organelles, for example. Such dynamic analysis makes it possible to obtain full-field tomographic images in fresh tissue, in which the cells are still alive, with excellent contrast and thus to visualise structures of biological objects that were previously not perceptible with OCT because the cells backscatter very little light compared with structures of the tissue such as collagen.

However, the FF-OCT and DC-FFOCT techniques described above work in reflection and are not adapted to highly transparent biological objects deposited onto a transparent substrate such as a transparent-bottomed glass or plastic Petri dish or a glass slide, for example. Indeed, the signal reflected by the substrate is typically three to five orders of magnitude greater than the signals backscattered by biological objects, for example cells, which makes it difficult to remove this signal.

The present description relates to a new method for three-dimensional imaging of a biological sample by full-field optical tomography, adapted to the three-dimensional imaging of transparent biological objects such as cell cultures or highly transparent thin structures, with excellent contrast and ease of implementation.

### SUMMARY

In the present description, the term “comprise” means the same as “include”, “contain”, and is inclusive or open-ended and does not exclude other elements not described or represented.

Furthermore, in the present description, the term “about” or “substantially” is synonymous with (means the same as) a lower and/or upper margin of 20%, for example 10%, of the respective value.

The present description relates, according to a first aspect, to a method for three-dimensional imaging of a transparent biological object in a biological sample by full-field optical tomography, the three-dimensional imaging method comprising:
positioning the sample in the vicinity of an object focal plane of a microscope lens, said microscope lens comprising a given optical axis;
illuminating the sample in transmission with an illumination beam of spatially incoherent light having a given central wavelength; and
relatively displacing said microscope lens relative to said sample, along an axial direction parallel to the optical axis of the microscope lens, to define a plurality of positions of the sample relative to the object focal plane of the microscope lens, each position corresponding to a section of said transparent biological object centred on the object focal plane of the microscope lens; and
for each position of the sample, producing at least one first image of an object field of said section comprising:
   acquiring, by means of a two-dimensional acquisition device comprising a plurality of elementary detectors arranged in a detection plane, a plurality of two-dimensional interferometric signals resulting from optical interference between the illumination beam incident on said object field and a beam scattered by said object field, wherein said detection plane is optically conjugated with the object focal plane of the microscope lens by an imaging optical system comprising said microscope lens;
   calculating, by means of a processing unit, said at least one first image from said plurality of two-dimensional interferometric signals.

By transparent biological object, it is understood in the present description any biological object with low scattering (typically less than about 5% of the incident light scattered by the object), through which the light from the illumination beam is likely to pass, for example: a cell or a plurality of cells, for example a cluster of cells, a cell scaffold, a cell mat or a biofilm, a thin slice of tissue such as that prepared in anatomical pathology, etc. Typically, the transparent biological objects of which it is sought to form (at least partial) images by means of the method according to the present description have microscopic dimensions (between about 1 μm and approximately 2 mm). When it is more precisely a cell or a plurality of cells, such transparent biological objects have dimensions of between about 2 microns and about 50 microns.

According to the present description, the transparent biological object forms part of a biological sample, that is, a substrate in which said transparent biological object is located. The biological sample is, for example and without limitation, a 2D or 3D cell culture in a transparent polymer, or the product of a fine needle biopsy (FNA) or “aspiration cytology”, that is, the product of sampling cells and tissue using a fine needle and a syringe.

In the three-dimensional imaging method object of the present description, the variation in phase of the beam scattered in the vicinity of the object focal plane of the microscope lens, called Gouy phase, is used to introduce phase shifts between the two-dimensional interferometric signals of the plurality of two-dimensional interferometric signals acquired to form said at least one first image. Beyond a certain distance from the object focal plane of the microscope lens, it can be shown that there is no longer any phase shift between the interferometric signals. It is therefore possible, by displacing the object focal plane of the microscope lens in a slice of given thickness of the biological object to be imaged, or by means of intrinsic motion of internal structures of the biological object in this same slice of given thickness, to acquire two-dimensional interferometric signals with different phase shifts, from which an image can be calculated.

The image of the biological object formed by means of the imaging method according to the present description is therefore the image of an object field of a slice of given thickness called “section” or “optical section” in the present description, hence the term optical tomography.

The applicants have shown that the thickness of this slice is in the order of the depth of field of the microscope lens and therefore depends on the numerical aperture of the microscope lens and the central wavelength of the illumination beam.

In the method according to the present description, the object field of the section of the biological object of which an image is formed can thus be defined by a volume of said biological object consisting of a set of volume elements or “voxels”, each voxel being comparable to a cylindrical volume of length equal to the depth of field of the microscope lens and of section defined by the diffraction disk of the microscope lens. The lateral dimensions of the object field (in a plane perpendicular to the optical axis of the microscope lens) are equal to the lateral dimensions of an image field defined by an effective detection surface of the detection plane, divided by a magnification value of the imaging optical system comprising said microscope lens. In example embodiments, the effective detection surface comprises the entire detection surface on which the elementary detectors or “pixels” of the two-dimensional acquisition device are arranged. In other example embodiments, the effective detection surface can be limited to a region of said detection surface, for example by means of a field diaphragm.

In practice, a voxel, or volume element of the object field of the section in the object space of the microscope lens, may correspond in the image space (detection plane) to a plurality of elementary detectors of the two-dimensional acquisition device, otherwise called “pixels” in the present description, in order to comply with the sampling criteria.

According to one or more example embodiments, working with central wavelengths of the illumination beam in the visible range (400 nm-700 nm), the thickness of a section of an object of which an image is formed by means of the method according to the present description, is between about 200 nm and about 10 microns for numerical apertures of the microscope lens of between 1.25 and 0.3. In practice, for a given numerical aperture of the microscope lens, it will be possible to work with shorter wavelengths in order to image thinner sections of the object.

The resolution of the image of an object field in a section is defined by a maximum lateral dimension of a voxel. In the visible range and for numerical apertures of the microscope lens between 1.25 and 0.3, the resolution is between about 0.25 microns and about 1 micron.

The relative displacement of the microscope lens relative to said sample, along an axial direction parallel to the optical axis of the microscope lens, then makes it possible to produce images of a plurality of sections of the transparent biological object to produce a three-dimensional image of said object.

The three-dimensional imaging method thus described enables tomographic imaging, including of transparent biological objects, by means of a novel optical arrangement in which the sample is lit in transmission.

According to one or more example embodiments, said plurality of two-dimensional interferometric signals are acquired for different positions of the object focal plane in the thickness of said section, resulting in a plurality of predetermined phase shifts between said illumination beam and said scattered beam ranging between −π/2 and π/2.

In the first embodiment described above, the method thus comprises, for the production of an image of an object field of a section of the biological object, relatively displacing said microscope lens relative to the sample, along an axial direction parallel to the optical axis of the microscope lens, the two-dimensional interferometric signals used to calculate the image of the object field of the section being acquired for different positions of the object focal plane of the microscope lens within said section, thus enabling the two-dimensional interferometric signals to be acquired with predetermined phase shifts.

According to one or more example embodiments, said calculation of said at least one first image comprises a linear combination of two-dimensional interferometric signals of said plurality of two-dimensional interferometric signals of a plurality of signals, for example the subtraction of two of said two-dimensional interferometric signals.

In practice, calculating said at least one first image comprises, for each elementary detector of the two-dimensional acquisition device, calculating a pixel value as a function of a linear combination of the intensities of said two-dimensional interferometric signals acquired by said elementary detector.

In the present description, by “pixel value”, it is understood the value of the signal measured by the corresponding pixel, or elementary detector.

According to one or more example embodiments, calculating a pixel value is a function of a linear combination of the intensities of two-dimensional interferometric signals acquired by varying the distance between the microscope lens and the sample by a distance of between approximately 1/10 of the depth of field and the depth of field, advantageously between approximately 1/10 and approximately ½ of the depth of field.

According to one or more example embodiments, the relative displacement of said microscope lens relative to said sample follows a periodic function of maximum amplitude λ/4, where λ is the central wavelength of the illumination beam, for example a continuous periodic function, for example a sine function, or a periodic ramp. The periodic function comprises a period determined as a function of an acquisition rate of the two-dimensional detector to allow temporal sampling adapted to the calculation of the image, for example 2, 3 or 4 acquisitions for one period.

According to one or more example embodiments of the three-dimensional imaging method according to the first aspect:
the two-dimensional interferometric signals of said plurality of two-dimensional interferometric signals are acquired for a fixed position of the microscope lens relative to said sample, and calculating said at least one first image of the object field of said section comprises:
calculating, for each elementary detector of the two-dimensional acquisition device, at least one pixel value as a function of a value of a parameter representative of the temporal variations in intensity of said two-dimensional interferometric signals acquired by said elementary detector.

In this second embodiment, an image of the object field of a section of the transparent biological object is produced without displacing the microscope lens relative to the sample.

The image is different from that calculated in the first embodiment because it is characteristic of the motions of the intrinsic structures of the biological object and therefore of the environment. In some embodiments, images of the biological object can be produced with both the first embodiment and the second embodiment because these images provide complementary information.

According to one or more example embodiments, said parameter is representative of the temporal dispersion of the intensities of said interferometric signals.

According to one or more example embodiments, calculating, for each elementary detector of the two-dimensional acquisition device, at least one pixel value, comprises calculating a Fourier transform of said interferometric signals acquired by said elementary detector as a function of time.

The present description relates, according to a second aspect, to a three-dimensional imaging system for imaging at least one transparent biological object in a biological sample by full-field optical tomography, the imaging system comprising:
a light source configured for the emission of an illumination beam of spatially incoherent light, of given central length, said illumination beam being configured to illuminate the sample in transmission;
an optical imaging system comprising a microscope lens with a given optical axis and a given object focal plane in the vicinity of which, in operation, the sample is positioned;
means for relatively displacing said microscope lens relative to said sample, along an axial direction parallel to the optical axis of the microscope lens;
a two-dimensional acquisition device comprising a detection plane, said detection plane being optically conjugated with the object focal plane of the microscope lens by said imaging optical system; and
a processing unit; wherein, for each section of a plurality of sections of said biological object:
said three-dimensional imaging system is configured for the acquisition, by means of said two-dimensional acquisition device, of a plurality of two-dimensional interferometric signals resulting from optical interference between said illumination beam and a beam scattered by said section;
said processing unit is configured to calculate, from said plurality of two-dimensional interferometric signals, at least one first image of an object field of said section.

Such a novel arrangement of the imaging system enables optical tomography imaging of a transparent biological object, whereby images of sections or “slices” of the biological object can be produced in order to produce a three-dimensional image.

According to one or more example embodiments, the two-dimensional interferometric signals of said plurality of two-dimensional interferometric signals are acquired for different positions of the object focal plane in the thickness of said section, resulting in a plurality of predetermined phase shifts between said illumination beam and said scattered beam ranging between −π/2 and π/2.

In this first embodiment of the imaging system according to the present description, the means for relatively displacing said microscope lens relative to said sample are configured not only to displace the object focal plane of the microscope lens within a section of the biological object in order to produce an image of said section, but also to displace the object focal plane along the optical axis in the sample to produce images of a plurality of sections of said biological object in order to produce a three-dimensional image.

According to one or more example embodiments, the calculation of said at least one first image comprises a linear combination of the two-dimensional interferometric signals of said plurality of two-dimensional interferometric signals.

According to one or more example embodiments, the two-dimensional interferometric signals of said plurality of two-dimensional interferometric signals are acquired for a fixed position of the microscope lens relative to said sample, and calculating said at least one first image of said section comprises:
calculating, for each elementary detector of the two-dimensional acquisition device, at least one pixel value as a function of a value of a parameter representative of the temporal variations in intensity of said two-dimensional interferometric signals acquired by said elementary detector.

In this second embodiment of the imaging system according to the present description, the means for relatively displacing said microscope lens relative to said sample can be configured only to displace the object focal plane along the optical axis in the biological object to be imaged in order to produce images of a plurality of sections of said biological object so as to produce a three-dimensional image.

The first and second embodiments can be implemented in a same imaging system according to the present description in order to obtain a plurality of first images and a plurality of second images of sections of the transparent biological object that is sought to be imaged.

### BRIEF DESCRIPTION OF THE FIGURES

Further advantages and characteristics of the imaging technique set forth above will become apparent from the detailed description below, made with reference to the figures in which:

FIG. 1A represents a schematic diagram of an example three-dimensional imaging system according to the present description.

FIG. 1B represents more precisely and schematically an object focal plane of the microscope lens in an example three-dimensional imaging system according to the present description.

FIG. 2A schematically illustrates, in an example implementation of a three-dimensional imaging method according to one embodiment, two positions of the object focal plane of the microscope lens within a section of a transparent biological object in order to make an image of an object field of said section.

FIG. 2B schematically illustrates, in an example implementation of a three-dimensional imaging method according to the first embodiment, a plurality of positions of the object focal plane of the microscope lens, the object focal plane being centred on different sections of a transparent biological object to make a three-dimensional image of said object.

FIG. 3A shows, by way of illustration, the theoretical intensity calculated in the centre of the image field for a two-dimensional interferometric signal resulting from the interference of an illumination beam and a beam scattered by a scattering particle as would be the case, for example, of a cellular organelle of nanometric dimensions, as a function of the relative position of the object focal plane of the microscope lens relative to the position of said particle.

FIG. 3B shows, by way of illustration, the theoretical intensity calculated and represented in FIG. 3A, from which a continuous background corresponding to an average value of the interferometric signal in z has been subtracted.

FIG. 3C shows, by way of illustration, in an example implementation of a three-dimensional imaging method according to the first embodiment, the difference between theoretical intensities calculated in the centre of the field respectively for two two-dimensional interferometric signals resulting from the interference of an illumination beam and a beam scattered by the particle, for two positions of the particle separated by a distance equal to one tenth of the given depth of field, as a function of the relative position of the object focal plane of the microscope lens relative to the position of said particle.

FIG. 3D shows, by way of illustration, the theoretical intensity calculated and represented in FIG. 3B, on which is superimposed a curve illustrating a relative displacement of the object focal plane of the microscope lens relative to the sample according to a sine function.

FIG. 4 schematically illustrates, in the implementation of a three-dimensional imaging method according to a second embodiment, the position of the object focal plane of the microscope lens relative to a section of a biological object to make an image of an object field of said section.

FIG. 5 shows, by way of illustration, the theoretical intensity calculated and represented in FIG. 3B, on which is superimposed a curve illustrating a random displacement of an intrinsic structure of the biological object relative to the object focal plane of the microscope lens.

FIG. 6 shows experimental images obtained on two neighbouring HeLa cells along two different section planes at a distance of 4 microns, with two embodiments of a method according to the present description.

### DETAILED DESCRIPTION

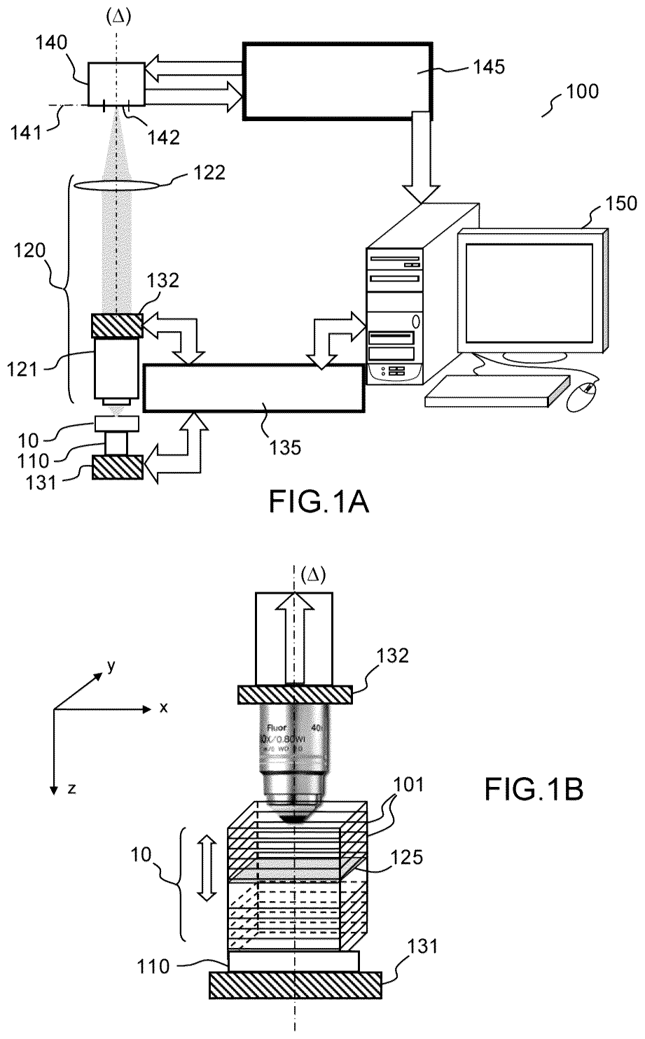

FIG. 1A and FIG. 1B schematically illustrate an example embodiment of a three-dimensional imaging system 100 according to the present description.

The imaging system 100 comprises a light source 110 configured to illuminate the sample 10 in transmission with an illumination beam of spatially incoherent light, of given central length λ. Advantageously, but not necessarily, the illumination beam is a temporally incoherent light beam to avoid unwanted optical speckle effects.

The source 110 is for example a light emitting diode (LED), a heating filament source, a matrix of source elements of the VCSEL (Vertical external Cavity Surface Emitting Laser) type, a laser associated with a membrane or any other means for making the illumination beam spatially incoherent.

In the examples illustrated in FIG. 1A and FIG. 1B, the source 110 is positioned against the sample 10 for the emission of the illumination beam in transmission, but other lighting configurations are also possible.

The three-dimensional imaging system 100 moreover comprises an optical imaging system 120 comprising a microscope lens 121 with an optical axis Δ and an object focal plane 125 (FIG. 1B) in the vicinity of which, in operation, the sample 10 is placed. In the example in FIG. 1A, the optical imaging system 120 moreover comprises an (optional) lens 122, generally called “tube lens”.

The three-dimensional imaging system 100 also comprises means for relatively displacing the microscope lens 121 relative to the sample 10, along an axial direction parallel to the optical axis of the microscope lens. In the example of FIG. 1A and FIG. 1B, the relative displacement means comprise a first piezoelectric element 131 configured to axially displace the microscope lens 121 and a second piezoelectric element 132 configured to axially displace a sample holder (not represented in the figures) on which the sample 10 is arranged. The relative displacement means also comprise a control unit 135 for controlling the elements 131, 132. In other embodiments, however, the relative displacement means may comprise only one element for displacing, either the microscope lens or the sample holder.

The three-dimensional imaging system 100 moreover comprises a two-dimensional acquisition device 140 comprising a detection plane 141, the detection plane 141 being optically conjugated with the object focal plane 125 of the microscope lens by the imaging optical system 120 and a control module 145 of the acquisition device 140. The two-dimensional acquisition device 140 comprises a plurality of elementary detectors or “pixels” arranged at the detection surface in the form of a matrix arrangement, for example a two-dimensional matrix arrangement. For example, the dimensions of the matrix arrangement of the elementary detectors define the dimensions of an image field 142 of the imaging system according to the present description. In other example embodiments, dimensions of the image field 142 are limited by a field diaphragm such that the effective detection surface in the detection plane or “R.O.I.” (for Region of Interest) is smaller than the surface covered by the two-dimensional arrangement of the elementary detectors. The image field is rectangular, for example, with dimensions of between about 5 mm and about 50 mm.

For example, the two-dimensional acquisition device is a CCD or CMOS type camera. Of course, other cameras may be used, for example ultra-fast cameras with a greater load capacity per pixel, for example a QUARTZ Series® type camera from ADIMEC®.

The control module 145 controls the acquisition of the acquisition device 140 and receives the electrical signals transmitted by the acquisition device 140 to send them to a processing unit 150.

As illustrated in FIG. 1A, the three-dimensional imaging system 100 comprises the processing unit 150 configured for the implementation of calculation and/or processing steps implemented in methods according to the present application.

Generally speaking, when in the present description reference is made to calculation or processing steps for the implementation especially of method steps, it is understood that each calculation or processing step may be implemented by software, hardware, firmware, microcode or any appropriate combination of these technologies. When software is used, each calculation or processing step can be implemented by computer program instructions or software code. These instructions may be stored in or transmitted to a computer-readable storage medium (or processing unit) and/or executed by a computer (or processing unit) in order to implement those calculation or processing steps.

Thus, in operation, as will be described in more detail later, the three-dimensional imaging system 100 is configured for the acquisition, by means of said two-dimensional acquisition device 140, of a plurality of two-dimensional interferometric signals resulting from optical interference between the illumination beam incident on the sample 10 and a beam scattered by said at least one transparent biological object of the sample 10, for example a cell or a cluster of cells. Moreover, the processing unit is configured to calculate, from the plurality of two-dimensional interferometric signals, one or more images of an object field of each section of a plurality of sections 101 of the biological object.

The lateral dimensions of the object field are equal to the lateral dimensions of the image field divided by a magnification of the optical imaging system 120 comprising the microscope lens.

Thus, for example, for a substantially rectangular image field with dimensions of 10 mm by 10 mm, the dimensions of the object field are 100 μm by 100 μm for a 100× magnification of the optical imaging system and 500 μm by 500 μm for a 20× magnification of the optical imaging system. Generally speaking, the dimensions of the object field are between about 50 μm and about 500 μm.

The object field of a section 101 of the biological object of which an image is formed can be defined by a volume consisting of a set of volume elements or “voxels”, each voxel being comparable to a cylindrical volume with a length equal to the depth of field of the microscope lens and with a section element defined by the diffraction disk of the microscope lens.

The depth of field L and the diameter ϕ of the section element are given by:

$$L = 1.22 \frac{λ n}{{NA}^{2}} \qquad [ Math 1 ]$$

$$Φ = 1.22 \frac{λ}{NA} \qquad [ Math 2 ]$$

Where n is the index of the medium in which the object space is immersed (for example a medium of index n≈1.5 in the case of an oil immersion lens), NA is the numerical aperture of the microscope lens in said medium, and λ is the central wavelength of the illuminating beam.

As depicted in FIG. 1B, each section 101 is substantially perpendicular to the optical axis Δ of the microscope lens. In operation, to produce an image of a section, the object focal plane of the microscope lens is centred on said section by means of a relative displacement of the microscope lens and the sample 10. From the images of the sections, a three-dimensional image of the transparent biological object can be produced.

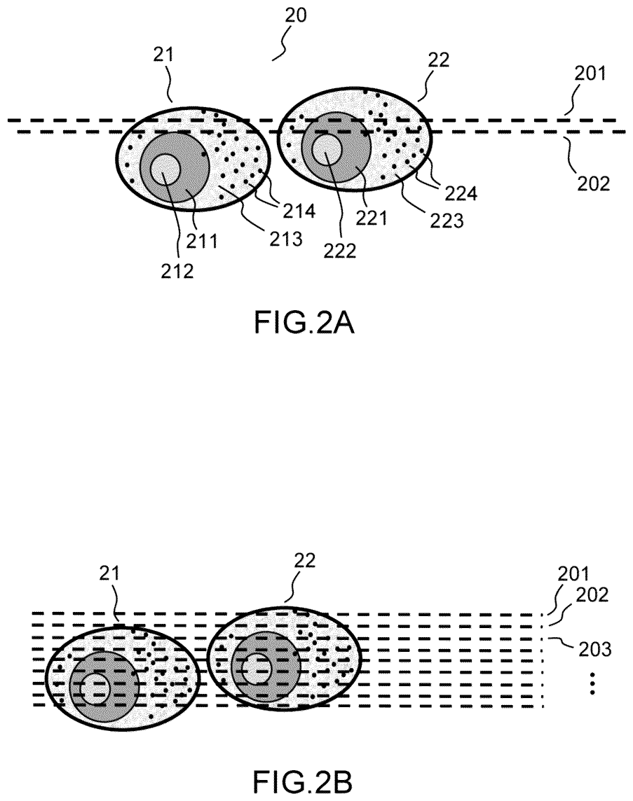

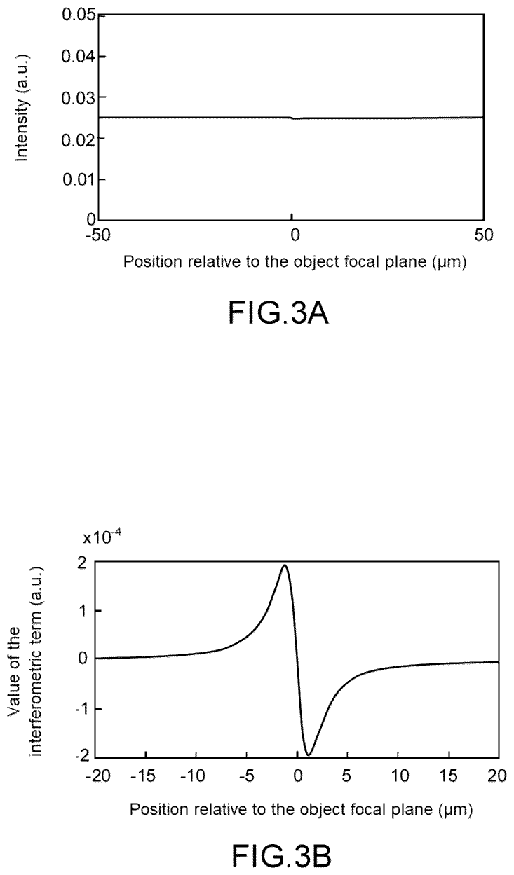

A first embodiment of a three-dimensional imaging method is described by means of FIG. 2A, FIG. 2B, FIG. 3A, FIG. 3B, FIG. 3C, FIG. 3D. This first embodiment describes a first mode for acquiring and calculating an image of an object field of a section.

In the acquisition mode according to the first embodiment, for the production of an image of an object field of a section of a transparent biological object, for example a cell or a cluster of cells, the object focal plane of the microscope lens is displaced within said section, along an axial direction parallel to the optical axis of the microscope lens.

A plurality of two-dimensional interferometric signals are acquired for different object focal plane positions within said section, resulting in a plurality of phase shifts between the incident beam and the beam scattered by said section ranging between −π/2 and π/2. The image of the entire object field of the section is then calculated directly from said two-dimensional interferometric signals, hence the concept of full-field imaging.

By way of illustration, FIG. 2A represents a cluster 20 of two cells 21, 22 of which a three-dimensional tomographic image is sought to be made. Each cell comprises a nucleus 211, 221 with a nucleolus 212, 222 and, around the nucleus, a cytoplasm 213, 223 containing cellular organelles 214, 224 such as mitochondria, vesicles, lipid bodies, protein condensates, etc. The organelles of the cytoplasm are located in the nucleus. The organelles of the cytoplasm or the internal structures of the nucleus of the cells scatter the light. As described below, from at least two two-dimensional interferometric signals acquired by varying the distance between the microscope lens and the sample, typically by a distance of between about 1/10 of the depth of field and the depth of field, for example between about 1/10 and about ½ of the depth of field, and therefore the phase of the interferometric signal, it is possible to calculate an image of the section in the volume of the cell, for example by difference pixel by pixel between the two interferometric signals acquired. The dotted lines 201, 202 illustrate, by way of example, two positions of the object focal plane of the lens within the section that is sought to be imaged.

To explain the principle of calculating an image of a section according to the first embodiment, it is assumed that the electromagnetic field received in the detection plane 141 of the acquisition device 140 (FIG. 1A) is the superposition of the incident field emitted by the source and transmitted by the sample, modelled in this example by a plane wave, and the field scattered by the cell, modelled at each voxel of the object field by a Gaussian beam which is suitable for an analytical formulation. The conclusions developed below remain valid in the case of an illumination beam that is not rigorously a plane wave or a scattered beam that is not rigorously comparable to a Gaussian beam.

It should be noted that due to the spatial incoherence of the illumination beam, the beam scattered by the entire object field can indeed be considered as a plurality of beams arranged side by side throughout the field of the biological object, the size of each beam being defined by the resolution of the microscope lens.

More precisely, the complex electric field of a Gaussian beam propagating along an axis z parallel to the optical axis of the microscope lens (FIG. 1B), in the scalar approximation, is written:

$$E ( r , z ) = {E}_{0} ( {w}_{o} / w ( z ) ) exp ( - {r}^{2} / w {( z )}^{2} ) exp ( - ikz - ik ( - {r}^{2} / 2 R ( z ) ) + i ζ ( z ) ) \qquad [ Math 3 ]$$

The coordinate z is defined along the optical axis of the microscope lens relative to an origin (z=0) defined at the object focal plane of the microscope lens; r is the distance from the optical axis, k=2π/λ where λ is the central wavelength of the illumination beam. E₀ and w₀ are the field and the size of the beam at the origin (z=0, r=0). It can be approximated that the size w₀ of the beam at the origin is equal to the radius ϕ/2 of the diffraction disk of the microscope lens given above [Math 2]. It should be noted that in practice, the size of the beam defines the dimension of the smallest accessible detail in the image. In order to obtain sampling in the interferometric signals acquired by the detection device that complies with the sampling theorem, also known as Shannon's theorem, for w₀, a value that is greater than or equal to the maximum size of a pixel may be chosen.

In the following, reasoning about r=0 will be performed, but in practice an extended object field is concerned and it can be shown that the curves described below are the same at any point in the object field in the absence of aberrations, which is in practice the case with microscope lenses.

For a Gaussian beam, the width of the beam w(z) is minimal at its origin (z=0) and is equal, at a distance z along the axis of the beam, to w(z)=w₀(1+(z/z₀)²)^{0.5}.

The depth of field is given by 2*z₀=πw₀_{²}/λ et and the radius of curvature of the wave is R(z)=z(1+(z/z₀)²).

From the expression of the electric field of the wave, a phase term, called the Gouy phase, can be introduced, which represents the phase jump that occurs at the focus and is given by:

$$ζ ( z ) = atan ( z / {z}_{0} ) \qquad [ Math 4 ]$$

A biological object, such as a cell, is comprised of internal structures of dimensions from about 10 nanometres to about 1 micrometre. For example, internal structures are cell organelles, filaments and microtubules, vesicles and mitochondria. To illustrate the axial response of the signals recorded, the example of such an internal structure is taken here, which is comparable to a particle or “scatterer” having a given position (z) relative to the object focal plane of the microscope lens.

The field scattered by the particle in the centre of the object field is therefore written:

$${E}_{scat} ( 0 , z ) = {E}_{0} \cdot \frac{σ}{A} . \frac{1}{1 + {( \frac{z}{{z}_{0}} )}^{2}} \cdot exp ( - ikz + i arctan ( \frac{z}{{z}_{0}} ) + i \frac{π}{2} ) , \qquad [ Math 5 ]$$

With σ/A, the ratio between the effective scattering cross-section of the particle and A, the area of the incident illumination beam.

The incident field is modelled by a plane wave:

$${E}_{inc} ( 0 , z ) = {E}_{0} \cdot ( 1 - \frac{σ}{A} ) \cdot exp ( - ikz ) \qquad [ Math 6 ]$$

Thus, the intensity measured by the acquisition device and corresponding to the two-dimensional interferometric signal in the centre of the field becomes, neglecting the exp(iωt) terms and the propagation terms common to both beams which are averaged at 0:

$$I = < ( {E}_{scat} + {E}_{inc} ) \cdot * ( {E}_{scat} + {E}_{inc} ) * > \qquad [ Math 7 ]$$

$$That is$$

$$I = {I}_{0} ( {( 1 - \frac{σ}{A} )}^{2} + {( \frac{σ}{A} \cdot \frac{1}{1 + {( \frac{z}{{z}_{0}} )}^{2}} )}^{2} + 2 ( 1 - \frac{σ}{A} ) \cdot ( \frac{σ}{A} \cdot \frac{1}{1 + {( \frac{z}{{z}_{0}} )}^{2}} ) cos ( arctan ( \frac{z}{{z}_{0}} ) + \frac{π}{2} ) ) \qquad [ Math 8 ]$$

Generally, for small particles, the effective cross-section is very small compared to 1, and the following can then be written:

$$I ( z ) = {I}_{0} ( 1 - 2 ( \frac{σ}{A} ) \cdot \frac{1}{1 + {( \frac{z}{{z}_{0}} )}^{2}} \cdot sin ( arctan ( \frac{z}{{z}_{0}} ) ) \qquad [ Math 9 ]$$

FIG. 3A thus illustrates the intensity curve I(z) calculated for σ/A=0.01 and z₀=0.25 μm (λ=0.5 μm, NA=1.25), that is a depth of field of 0.5 μm.

This property of variation in the interferometric signal measured in the detection plane as a function of the position of the scattering particle is utilised to calculate an image of an object field of a section of the transparent biological object, for example a cell.

As previously explained, the relative position of the microscope lens with the sample is modified, for example by means of a piezoelectric element (132, FIG. 1A). It is then possible to vary the value of z and obtain several different interferometric signals.

More precisely, the linearity of the interference term in the vicinity of z=0 is utilised (FIG. 3B) to obtain the effective cross-section of the objects which are located at the focus of the microscope lens. In this example, FIG. 3B represents a curve obtained by the curve shown in FIG. 3A from which an average background has been subtracted.

In the vicinity of the focus, the sine and arctan functions can be linearised and the prefactor in 1/(1+(z/z0)²)) removed. Equation [Math 9] becomes:

$$I ( z ) ∼ {I}_{0} ( 1 - 2 ( \frac{σ}{A} ) \cdot \frac{z}{{z}_{0}} ) \qquad [ Math 10 ]$$

On the curve illustrated in FIG. 3B, it can be observed that the linearity zone extends over a zone in the order of one micron.

By taking two successive images for positions z distant of 0.1 μm, for example, obtained by moving the lens (or the sample), and measuring the difference between the two interferometric signals, it is obtained:

$$Δ I ( z ∼ 0 ) ∼ - 2 \cdot {I}_{0} \cdot ( \frac{σ}{A} ) \cdot \frac{Δ z}{{z}_{0}} \qquad [ Math 11 ]$$

which is directly proportional to σ, the effective scattering cross-section of the particle.

Moreover, if the particle is far from the focus, the intensity of the interference term tends towards 0, because the sin(atan(z)) tends towards 0, and the prefactor (1/(1+z²)) also tends towards 0 when z becomes large.

As a result, if the particles are far from the focus, the difference between successive images shifted by Δz˜1 μm is ΔI (z>>z₀)=0.

Thus, the intensity difference is non-zero only if the object is close to the focus of the lens.

The imaging method according to the present description therefore enables “optical sectioning”, that is, the image of a section of the sample of given thickness. In other words, if a 3D object comprised of several scatterers/particles is looked at, by making this image difference at two positions, only the scatterers present at a given depth are isolated, and the structure of the 3D object (its composition in scatterers) at a given depth can be obtained.

The phase shift of −π/2 and π/2 occurs at distances in the order of the depth of field z₀ of the microscope lens. To obtain a thin section of the sample, lenses with a large numerical aperture should be used. For example, for oil immersion lenses with a numerical aperture of 1.25, the depth of field is 0.5 μm, whereas for water immersion lenses often with a numerical aperture of 0.9, the depth of field is 1 μm.

In the general case of the above curves, it is possible to plot the difference in intensity between two images, pixel by pixel, taken at a distance in the order of the depth of field, for example 1/10 of the depth of field, for different positions of a scatterer, as illustrated in FIG. 3C.

It is observed from the curve illustrated in FIG. 3C that the scatterer is only visible if it is located close to the focus. An arbitrary criterion (for example, full width at half maximum) can be defined to define the optical section, that is, the thickness over which a scatterer is detectable, and it is seen here that it is in the order of the depth of field of the apparatus, that is, in the order of 0.5 microns for an oil lens with a numerical aperture of 1.25).

In practice, it is determined that it is interesting to choose interferometric signals obtained for axial differences of between 0.1 and 0.4 microns.

In practice, for a high rate work, the piezoelectric elements are not always adapted to produce an instantaneous square-wave displacement, and it may be preferable to perform a sinusoidal modulation of the displacement. As it is in a zone where the optical response is linear for z˜0, the variation in the optical signal is also sinusoidal, which can be filtered very well by synchronous detection, taking 4 images for example.

If the scatterer is outside this linear zone, synchronous detection no longer enables a signal to be detected.

From an image of an optical section, it is then possible to scan the sample in the volume as illustrated in FIG. 2B. “Tomography” is then performed, that is, a measurement of the intensity scattered by the slices at different corresponding axial positions providing a 3D image of the sample.

For example, the object focal plane can be positioned at a position referenced 201 in FIG. 2B, an acquisition of an interferometric signal can be made in this plane as well as in a plane referenced 202 apart from plane 201 by 0.2 micrometres. The difference between the two-dimensional interferometric signals is then calculated to determine an image of a first section, and then the object focal plane is displaced and new acquisitions are made to determine an image of a following section. For example, the object focal plane can be displaced in a plane referenced 203 and an interferometric signal acquired in this plane, differentiated from the interferometric signal acquired in the plane 202 to calculate an image of another optical section, and so on.

The relative position of the microscope lens and the sample can also be periodically modulated by applying a sinusoidal voltage to one of the two piezoelectric displacements in FIG. 1.

Synchronous detection of the signals is then performed by taking a time sampling of at least 2 images over half a period.

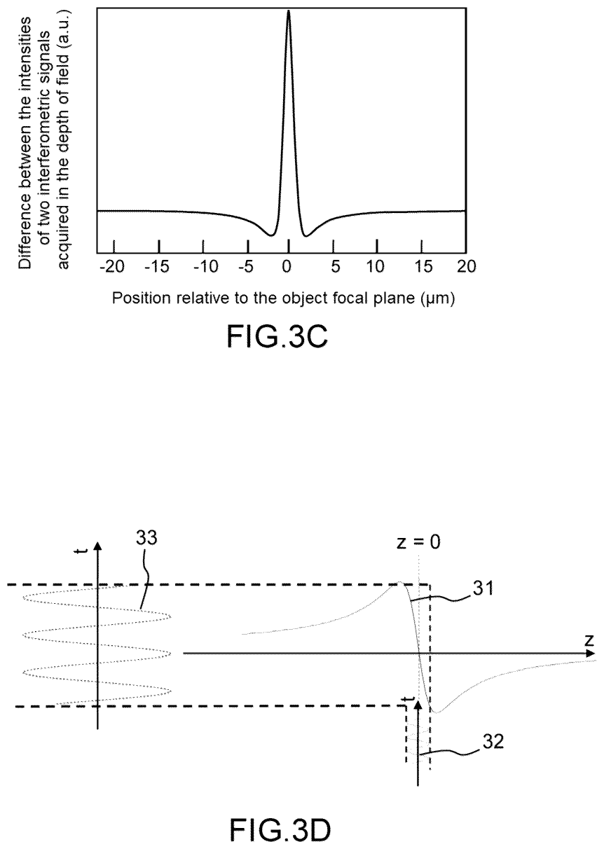

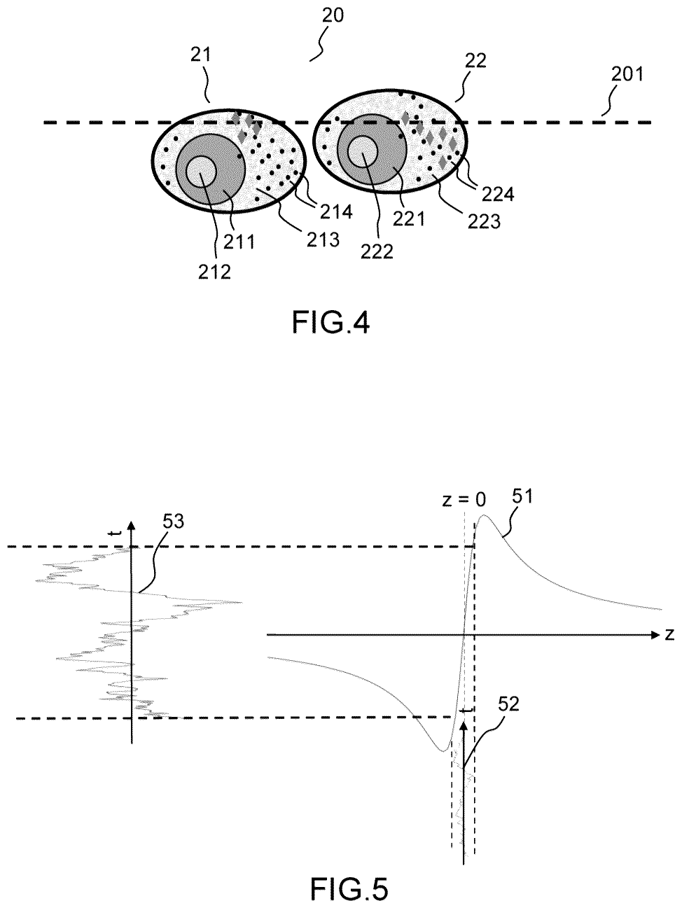

A second embodiment of a three-dimensional imaging method is described by means of FIG. 4 and FIG. 5. This second embodiment describes another mode for acquiring and calculating an image of a section, different from that described in relation to the preceding figures. It should be noted that it is possible to calculate, for each section, a first image corresponding to the first embodiment and a second image corresponding to the second embodiment.

In the previous embodiment, a relative displacement of the microscope lens and the sample is performed to measure intensity differences at two different positions.

However, the applicants have found that most organelles in biological objects have internal motions that modulate their positions spontaneously.

Thus, in the second embodiment of tomographic imaging methods according to the present description, the microscope lens is not displaced relative to the sample for the calculation of an image of an optical section, as detailed below. Relative displacement is only performed to calculate images of different optical sections and thus reconstruct a three-dimensional image.

In practice, however, the displacement of biological objects is not known a priori, as this displacement is a priori random, whereas ΔI˜σ.Δz [Math 11], so neither the effective cross-section of the scatterer nor its displacement can be determined, and a single scatterer cannot be characterised.

In the tomographic imaging method according to the second embodiment, the calculation of an image of an object field of an optical section is performed from temporal variations in intensity between said two-dimensional interferometric signals acquired for a given position of the object focal plane within the section.

For example, for each elementary detector of the two-dimensional acquisition device, a pixel value can be calculated as a function of a value of a parameter representative of the temporal variations in intensity of said two-dimensional interferometric signals acquired by said elementary detector. The parameter is for example representative of the temporal dispersion of the intensities of the interferometric signals.

Indeed, the temporal fluctuations or variation in the intensity signal give information about the fluctuation in the position of the scatterers. For example, if the scatterers have Brownian motion (random fluctuation in position), the measured intensity signal has to be purely random with a ΔI that has to increase statistically as \sqrt{t} (or as the square root of the time difference between images). In practice, scatterers in biological cells are more often considered. The physiology of the cell means that the motions are no longer random, but biased, because the cell controls the motion of the scatterers (for example by molecular motors). It could be shown that by measuring the fluctuation in the intensity signal created by the motion of the scatterers, a specific signal that depends on the metabolism of the cell can be obtained.

In practice, N images are recorded in the same plane as a function of time. The signal is a priori random because the position of the scatterers is also random, as illustrated in FIG. 5.

From this time trace, statistical processing can be performed to provide information about the environment of the scatterer. Sensitivity to motions of the scatterers is only valid for scatterers in the optical section, that is, very close to the focal plane. Signal fluctuations are therefore mainly caused only by scatterers coming from the focal volume.

Thus, dynamic tomography can finally be performed, that is, recording the signal fluctuations in one plane, performing the analysis, moving the position of the lens, and starting again, and so on. The environment of the scatterers is thus mapped in 3D.

For example, each pixel of the camera records a signal which is a time series that needs to be analysed and represented. There are several ways of performing this analysis. For example, the Fourier transform of the time series of interferometric signals can be calculated to deduce a number of pixel values therefrom, for example values corresponding to the power (integral over the spectrum of the squared modulus of the FT), the centre frequency of the frequency spectrum (H) and the spectral width (S) respectively. For example, an HSV (Hue, Saturation, Value) colour representation can be used to represent the central frequency of the frequency spectrum (H), the spectral width (S) and the power (V) respectively.

Other analysis means can be used, such as the simple calculation of the standard deviation of the time series of interferometric signals or the analysis of the cumulative sums (cumsum function) of said time series for biased motions.

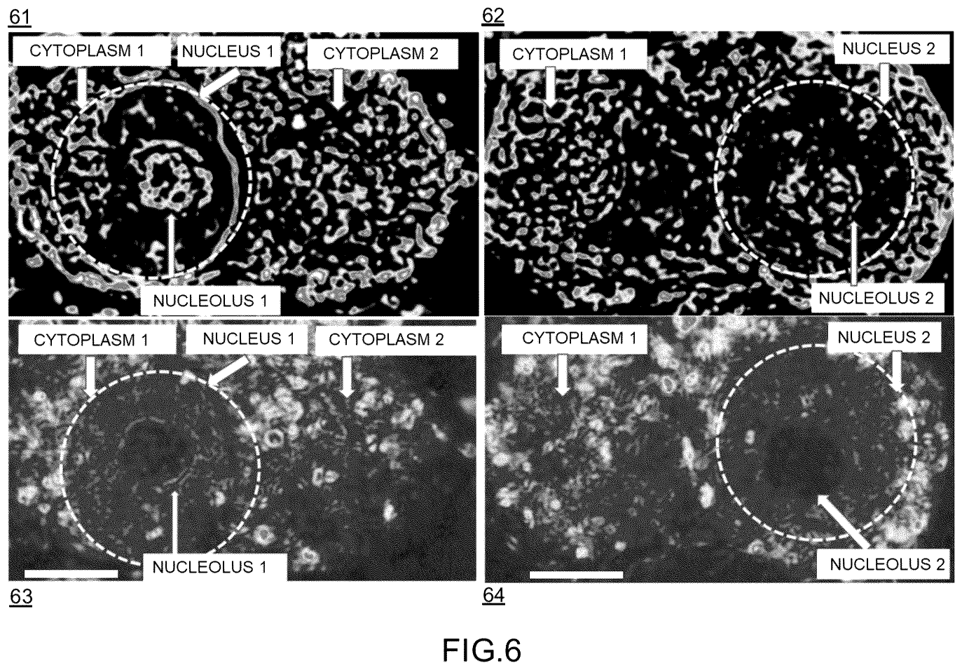

FIG. 6 represents images of two sections of HeLa cancer cells distant of 4 microns and obtained by means of an imaging system according to the present description, similar to that represented in FIG. 1A. The microscope lens is an oil immersion 100× magnification lens with a numerical aperture of 1.25 and the central wavelength is equal to 450 nanometres. The camera used is a Photon Focus® MV-D1024E Series CMOS camera.

To make this image, the object focal plane of the microscope lens is displaced to be centred on two sections of the cell, a first section at the cytoplasm (61, 63) and a second section at the nucleus of the cell (62, 64). These images illustrate the ability of the method object of the present description to tomograph cells. The bottom images 63, 64 represent the morphology of the cell, the top images 61, 62 the “dynamic” part. The scale bar is equal to 2 microns.

Although described through a certain number of example embodiments, the tomographic imaging methods and systems according to the present description comprise various alternatives, modifications and improvements which will be obvious to the person skilled in the art, it being understood that these various alternatives, modifications and improvements form part of the scope of the invention as defined by the following claims.

1-11. (canceled)

12. A method for three-dimensional imaging of a transparent biological object in a biological sample by full-field optical tomography, the three-dimensional imaging method comprising:
positioning the sample in the vicinity of an object focal plane of a microscope lens, said microscope lens comprising a given optical axis (Δ);
illuminating the sample in transmission by an illumination beam of spatially incoherent light with a given central wavelength (λ);
relatively displacing said microscope lens relative to said sample, along an axial direction parallel to the optical axis of the microscope lens, to define a plurality of positions of the sample, each position corresponding to a section of said biological object centred on the object focal plane of the microscope lens; and for each position of the sample, producing at least one first image of an object field of said section comprising:
acquiring, by a two-dimensional acquisition device comprising a plurality of elementary detectors arranged in a detection plane, a plurality of two-dimensional interferometric signals resulting from optical interference between the illumination beam incident on the object field and a beam scattered by said object field, wherein said detection plane is optically conjugated with the object focal plane of the microscope lens by an imaging optical system comprising said microscope lens;
calculating, by a processing unit, said at least one first image, from said plurality of two-dimensional interferometric signals.

13. The imaging method according to claim 12, wherein the two-dimensional interferometric signals of said plurality of two-dimensional interferometric signals are acquired for different positions of the object focal plane in the thickness of said section, resulting in a plurality of predetermined phase shifts between said illumination beam and said scattered beam ranging between −π/2 and π/2.

14. The imaging method according to claim 13, wherein the calculation of said at least one first image comprises a linear combination of said plurality of two-dimensional interferometric signals.

15. The imaging method according to claim 13, wherein the relative displacement of said microscope lens relative to said sample follows a periodic function of maximum amplitude λ/4, where λ is the central wavelength of the illumination beam.

16. The imaging method according to claim 12, wherein:
the two-dimensional interferometric signals of said plurality of two-dimensional interferometric signals are acquired for a fixed position of the microscope lens relative to said sample, and
calculating said at least one first image of the object field of said section comprises calculating, for each elementary detector of the two-dimensional acquisition device, at least one pixel value as a function of a value of a parameter representative of the temporal variations in intensity of said two-dimensional interferometric signals acquired by said elementary detector.

17. The imaging method according to claim 16, wherein said parameter is representative of the temporal dispersion of the intensities of said interferometric signals.

18. A three-dimensional imaging system for imaging a transparent biological object in a biological sample by full-field optical tomography, the imaging system comprising:
a light source configured for the emission of an illumination beam of spatially incoherent light, of given central length, said illumination beam being configured to illuminate the sample in transmission;
an optical imaging system comprising a microscope lens with a given optical axis (A) and a given object focal plane in the vicinity of which, in operation, the sample is positioned;
means for relatively displacing said microscope lens relative to said sample, along an axial direction parallel to the optical axis of the microscope lens;
a two-dimensional acquisition device comprising a plurality of elementary detectors arranged in a detection plane, said detection plane being optically conjugated with the object focal plane of the microscope lens by said optical imaging system; and
a processing unit;
and wherein, for each section of a plurality of sections of said biological object:
said three-dimensional imaging system is configured for the acquisition, by said two-dimensional acquisition device, of a plurality of two-dimensional interferometric signals resulting from optical interference between said illumination beam and a beam scattered by an object field of said section;
said processing unit is configured to calculate from said plurality of two-dimensional interferometric signals at least one first image of said object field of said section.

19. The imaging system according to claim 18, wherein the two-dimensional interferometric signals of said plurality of two-dimensional interferometric signals are acquired for different positions of the object focal plane in the thickness of said section, resulting in a plurality of predetermined phase shifts between said illumination beam and said scattered beam ranging between −π/2 and π/2.

20. The imaging system according to claim 19, wherein the calculation of said at least one first image comprises a linear combination of the two-dimensional interferometric signals of said plurality of two-dimensional interferometric signals.

21. The imaging system according to claim 18, wherein the two-dimensional interferometric signals of said plurality of two-dimensional interferometric signals are acquired for a fixed position of the microscope lens relative to said sample, and calculating said at least one first image of the object field of said section comprises:
calculating, for each elementary detector of the two-dimensional acquisition device, at least one pixel value as a function of a value of a parameter representative of the temporal variations in intensity of said two-dimensional interferometric signals acquired by said elementary detector.

22. The imaging system according to claim 21, wherein said parameter is representative of the temporal dispersion of the intensities of said two-dimensional interferometric signals.
